(19) United States
(12) Patent Application Publication
(10) Pub. No.: US 2024/0171897 A1
(43) Pub. Date: May 23, 2024

(54) Adjustable and Retractable Headset For Enhanced Hearing Experience

(71) Applicant: Justin Lee, Upper Marlboro, MD (US)

(72) Inventor: Justin Lee, Upper Marlboro, MD (US)

(21) Appl. No.: 18/057,943

(22) Filed: Nov. 22, 2022

(51) Int. Cl. H04R 1/10; G10K 11/08; G10K 11/28

(52) U.S. Cl. CPC H04R 1/1091; G10K 11/08; G10K 11/28

(57) ABSTRACT

Disclosed herein is a headset for enhanced hearing experience. The headset comprises a headband placed in a rear of a user's head facing inward for comfort and modernization. The headset includes at least two spherical assemblies that fit ears of plurality of users for augmenting sound for the users. The spherical assemblies comprise a first earcup attached to one end of the headband via an adapter assembly and a second earcup connected to the other end of the headband via the adapter assembly. The first earcup and the second cup have an inner surface for engagement against an ear of the user. The adapter assembly being pivotally attached to the headband and to the first earcup and the second earcup, permitting inward and outward pivotal movement of the first earcup and the second earcup with respect to the headband.

### TECHNICAL FIELD

The present invention generally relates to the field of headsets. More particularly, embodiments of the disclosed invention provide an adjustable and retractable wireless headset for enhancing sound.

### BACKGROUND ART

Hearing aids have grown into a multibillion-dollar industry around the world as a means of improving hearing for the elderly, disabled, hearing-impaired, children in overcrowded classrooms, and for entertainment. With the rise in the cost of such devices, as well as the economy's fiscal volatility, it is becoming increasingly difficult to afford practical and beneficial devices. It is not fair to the average consumer to suffer professionally and academically as a result of a product that should be affordable.

Vocational health is a major concern in today's society, and people are becoming more aware of their physical health. Hearing protection of various types is readily available to mitigate potential hearing damage in noisy environments. However, using these hearing protection devices has a negative impact on people's ability to hear and thus communicate.

Individuals are fitted with custom internal-canal headsets. An audiologist will usually make ear canal castings. Custom headsets are more expensive due to the individualized labor involved. As a result, better internal-canal earbuds are required. The preceding discussion is intended only to highlight some of the shortcomings that existed in the field of the invention at the time and should not be interpreted as a denial of claim scope.

Along with the high price tags, technology is shifting toward environmentally friendly devices made of recyclable plastics that aid in the preservation of the natural environment. These materials are inexpensive, safe for children, and help to protect the environment.

As a result of the foregoing, there is an obvious need for a technical solution that overcomes the limitations mentioned above. The current disclosure focuses on a wireless headset that can be adjusted to improve sound quality.

### SUMMARY OF THE DISCLOSURE

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

According to illustrative embodiments, the present disclosure focuses on an adjustable wireless headset for enhancing sound which partially overcomes the above-mentioned disadvantages or provides the users with a useful or commercial choice.

The object of the present invention is to provide an adjustable wireless headset which is environment friendly while catering to the needs of individuals of all ages, young and old. Affordable amplifiers are designed to provide comfort that not only amplifies the volume of sound, but also amplifies the quality of sound. Although the device was designed as an affordable opportunity for children to learn effectively and better understand teachers in overcrowded classroom situations, there are also a number of other applications that have relevance including medical, entertainment, domestic and professional environments

According to the first aspect of the present disclosure, a headset for enhanced hearing experience is disclosed. The headset comprises a headband placed in the rear of a user's head facing inward for comfort and modernization. The headset includes at least two spherical assemblies that fit ears of plurality of users for augmenting sound for the users. The spherical assemblies comprise a first earcup attached to one end of the headband via an adapter assembly and a second earcup connected to the other end of the headband via the adapter assembly. The first earcup and the second cup have an inner surface for engagement against an ear of the user. The adapter assembly being pivotally attached to the headband and to the first earcup and the second earcup, permitting inward and outward pivotal movement of the first earcup and the second earcup with respect to the headband.

In one embodiment of the present invention, the headband may be made of recyclable plastic.

In one embodiment of the present invention, the at least two spherical assemblies are designed as personal amphitheaters.

According to the second aspect of the present disclosure, an adjustable and retractable headset to enhance the volume of sound in areas of interest is disclosed. The adjustable and retractable headset comprises a headband having a first end and a second end, the headband being placed to the rear of a user's head facing inward for comfort and modernization. The adjustable and retractable headset may comprise at least two circular assemblies that fit ears of plurality of users for augmenting sound for the users. The circular assembly comprises a first earcup attached to a first end of the headband via an adapter assembly and a second earcup connected to the second end of the headband via the adapter assembly. The adapter assembly being pivotally attached to the first end of the headband permitting inward and outward pivotal movement of the first earcup and the second earcup with respect to the headband. The adjustable and retractable headset comprises a mechanism associated with the headband and each of the two circular assemblies for selectively adjusting the extent of outward pivotal movement of each of the two circular assemblies with respect to the headband.

In one embodiment of the present invention, the adapter assembly may be connected via a hole present in the first earcup and the second earcup associated with the headband that are opened face pointing forward and enclosed around the ear.

In one embodiment of the present invention, the headband may be a retractable headband.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure.

FIG. 1A illustrates a front view of a headset for enhanced sound experience, according to embodiments of the present invention as disclosed herein;

FIG. 1B illustrates a rear view of the headset for enhanced sound experience, according to embodiments of the present invention as disclosed herein;

FIG. 1C illustrates a front view of a Styrofoam tubing in an adjustable and retractable headset for enhanced sound experience, according to embodiments of the present invention as disclosed herein;

FIG. 1D illustrates a side view of the Styrofoam tubing in an adjustable and retractable headset for enhanced sound experience, according to embodiments of the present invention as disclosed herein; and

FIG. 2 illustrates a side view of an adjustable and retractable headset for enhanced sound experience, according to embodiments of the present invention as disclosed herein.

FIG. 3 illustrates folded view of an adjustable and retractable headset for enhanced sound experience, according to embodiments of the present invention as disclosed herein.

The adjustable and retractable headset is illustrated in the accompanying drawings, which like reference letters indicate corresponding parts in the various figures. It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DESCRIPTION OF EMBODIMENTS

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively, and any and all combinations of any or more of such steps or features.

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The present invention discloses an adjustable and retractable headset attached to recyclable plastic spherical assemblies, which reduces costs while significantly increasing the ability to focus enhanced sound.

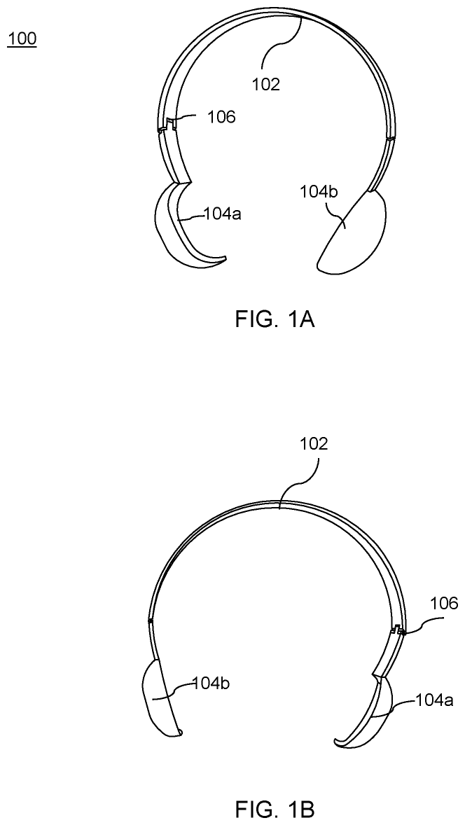

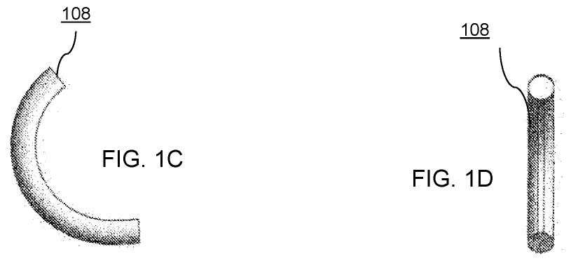

The present invention is disclosed to enhance the sound as a main component. FIG. 1A illustrates a front view of a headset for enhanced sound experience, according to embodiments of the present invention. The headset 100 may be an adjustable headset which may be made of recyclable organic plastic materials. The adjustable headset 100 may be used to enhance sound. The adjustable headset 100 may be made of plastic and does not require any electrical components, transmitters, receivers, or amplifiers to function. The adjustable headset 100 does not require batteries or electricity to operate.

Further, the headset 100 may comprise a headband 102 placed in a rear of a user's head facing inward for comfort and modernization. In a preferred embodiment of the present invention, the headband 102 may be a retractable headband. In another embodiment of the present invention, the headband 102 may be a curved shaped headband for displacement towards the back of the head of the user to rest on the ears.

The headset 100 may also include at least two spherical assemblies 104a, 104b that fit ears of plurality of users for augmenting sound for the users. The spherical assemblies 104a, 104b may comprise a first earcup 104a attached to one end of the headband 102 via an adapter assembly 106. Further, the spherical assemblies 104a, 104b may comprise a second earcup 104b connected to the other end of the headband 102 via the adapter assembly 106.

The spherical assemblies 104a, 104b may be designed as personal amphitheaters. The first earcup 104a and the second cup 104b have an inner surface for engagement against an ear of the user.

Further, the headset 100 further comprises the adapter assembly 106 that may be pivotally attached to the headband 102 and to the first earcup 104a and the second earcup 104b, permitting inward and outward pivotal movement of the first earcup 104a and the second earcup 104b with respect to the headband 102.

The headband 102 could be 10 inches long and made of close cell plastic to apply pressure to the back of the head and rest behind both ears. The headband 102 may be horizontally positioned in the forward position, facing openly. The embodiment is made of recyclable plastic and can be adjusted to fit people of all ages. The headset 100 can be adjusted to fit both children and adults. In an embodiment of the present invention, the headband 102 may be made of recyclable plastic.

In an embodiment of the present invention, the headset 100 may be made up of at least two spherical assemblies 104a, 104b, which may be support cups to help users hear better.

The adjustable headset 100 could be a wireless headset that is environmentally friendly. The first cup 104a and the second cup 104b provide ear support and increase the volume of sound in areas of interest.

The spherical cups 104a and 104b are also assembled with an open face pointing in the forward direction. The cups are also made from recyclable plastic, these uniquely designed cups function as hearing amplifiers to focus vibration waves directly to the external ear canal for an enhanced effect.

In one of the embodiments of the present invention, each of the spherical assembly 104a, 104b may be approximately four inches and the headband may be of approximately 10 inches. Each of the two spherical assemblies 104a, 104b may comprise Styrofoam liners 108 for providing comfort and solidify sounds within the ear canal for a personal amphitheater experience, as seen in FIG. 1C and FIG. 1D. In another embodiment of the present invention, the Styrofoam liner 108 trails along the edges of the spherical cups 104a, 104b. Further, an inner surface of the first earcup 104a and second earcup 104b are lined with Styrofoam 108.

Each of the spherical cups 104a, 104b are made from environmentally friendly plastic and are made in multiples of two for each set of headsets. There is ⅜″ hole in the center which allow for connection of the first earcup 104a and the second earcup 104b to the headband 102 through the adapter assembly 106. The first earcup 104a and the second earcup 104b are placed along the side of the head around the ear, open faced forward.

The headband 102 may be lightweight, environmentally friendly plastic, child friendly, and adjustable to accommodate youths and adults.

The first and second cups 104a, 104b have a circular design that enhances sound for a full amphitheatre effect at a low cost to assist with hearing amplification. The adjustable headset is free of chemicals such as DEHP, which are known to cause birth defects and other reproductive harm. The submitted distinctive mark focuses on the universal symbol of sound to highlight the utility of the headset while also distinguishing the brand.

The headset 100 is being worn around the ears rather than inside the ear canal. The smallest bones in our bodies are located in the ear, allowing our ears to convert vibration into sound. The headset 100 directs forward hearing to the cochlea, which generates nerve impulses in response to sound vibrations.

In an embodiment of the present invention, the adapter assembly 106 may comprise a mechanism associated with the headband 102. Additionally, the mechanism may be engageable against the adapter assembly 106 to limit the extent of outward pivotal movement of the first earcup 104a and the second earcup 104b with respect to the headband 102.

The adapter assembly 106 may be connected via a hole present in the first earcup 104a and the second earcup 104b where the adapted assembly 106 may be associated with the headband 110 that are opened face pointing forward and enclosed around the ear.

The adapter assembly 106 may be ½″ is diameter and is made from recyclable plastic. Further, the adapter assembly 106 solely functions to maintain the adjustable headset 100.

Referring to FIG. 1C and FIG. 1D, the Styrofoam tubing 108 may be attached to the edge of the first and second earcups 104a, 104b in one embodiment of the present invention. The Styrofoam tubing 108 may be 4″ long and is tracked around the liner for comfort. To increase user comfort, the Styrofoam tubing 104 can be attached to both spherical cups 104a, 104b. The Styrofoam tubing material has a small curvature for the intended use of simple integration.

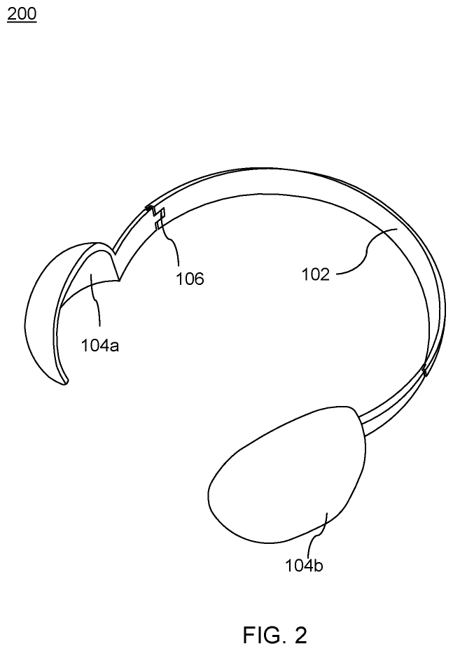

Referring to FIG. 2, an adjustable and retractable headset 200 to enhance the volume of sound in areas of interest is disclosed. The adjustable and retractable headset 200 may comprise the headband 102 having a first end and a second end. The headband 102 is placed to the rear of a user's head facing inward for comfort and modernization. The headband 102 may be curved shaped headband for displacement towards the back of the head of the user to rest on the ears. The headband is made of recyclable plastic.

The adjustable and retractable headset 102 may comprise at least two circular assemblies 104a, 104b that fit ears of plurality of users for augmenting sound for the users.

The circular assemblies 104a, 104b may comprise a first earcup 104a attached to a first end of the headband 102 via an adapter assembly 106 and a second earcup 104b is connected to the second end of the headband 102 via the adapter assembly 106. Each of the two spherical assemblies 104a, 104b comprises Styrofoam liners 108 for providing comfort and solidify sounds within the ear canal for a personal amphitheater experience. In one of the preferred embodiments of the present invention, the Styrofoam liner trails along the edges of the spherical cups. An inner surface of the first and second earcups are lined with Styrofoam.

The adapter assembly 106 being pivotally attached to the first end of the headband 102 permitting inward and outward pivotal movement of the first earcup 104a and the second earcup 104b with respect to the headband 102. In an embodiment of the present invention, the adjustable headset 100 may be retractable and waterproof.

The adjustable and retractable headset 100 may comprise a mechanism associated with the headband 102 and each of the two circular assemblies 104a, 104b for selectively adjusting the extent of outward pivotal movement of each of the two circular assemblies 104a, 104b with respect to the headband 102. The adjustable and retractable headset 200 may be waterproof.

The low-cost amplifiers are intended to provide comfort by increasing not only the volume but also the quality of the sound. The headset 100 is intended to provide an affordable opportunity for children to learn more effectively and better understand teachers in overcrowded classroom settings. However, there are a variety of other applications that may be relevant, including medical, entertainment, domestic, and professional settings.

The headset 100 is also waterproof, compact, and offers a low-cost solution for children to learn more effectively and better understand teachers in overcrowded classrooms. Furthermore, the headset 100 is designed for Senior Citizens who are deaf. The headset is also available in a variety of colors and designs.

The headset 100 may be made of lightweight plastic which is durable and allow for simple attachment over the ear for an enhanced listening experience.

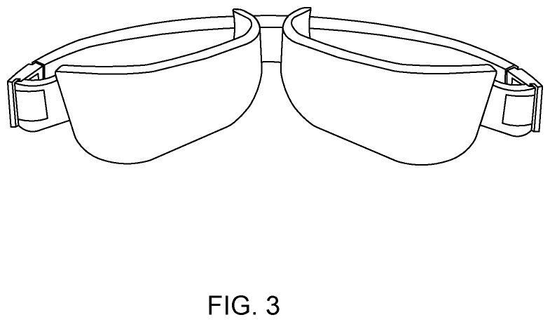

Referring to FIG. 3, shows a folded view of the retractable headset.

While the invention has been described in connection with what is presently considered to be the most practical and various embodiments, it will be understood that the invention is not to be limited to the disclosed embodiments, but on the contrary, is intended to cover various modifications and equivalent arrangements included within the scope of the appended claims.

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present technology have been presented for the purpose of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical software, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the software or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present disclosure and the features in the embodiments may be mutually combined. The foregoing descriptions are merely specific implementations of the present disclosure but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A headset for enhanced hearing experience, the headset comprising:
a headband placed in a rear of a user's head facing inward for comfort and modernization;
at least two spherical assemblies that fit ears of plurality of users for augmenting sound for the users, the spherical assemblies comprise:
assembly,
a first earcup attached to one end of the headband via an adapter a second earcup connected to the other end of the headband via the adapter assembly,
wherein the first earcup and the second cup having an inner surface for engagement against an ear of the user; and
the adapter assembly being pivotally attached to the headband and to the first earcup and the second earcup, permitting inward and outward pivotal movement of the first earcup and the second earcup with respect to the headband.

2. The headset of claim 1, wherein the headband is a retractable headband.

3. The headset of claim 1, wherein the adapter assembly comprises a mechanism associated with the headband, the mechanism being engageable against the adapter assembly to limit the extent of outward pivotal movement of the first earcup and the second earcup with respect to the headband.

4. The headset of claim 1, wherein the at least two spherical assemblies are designed as personal amphitheaters.

5. The headset of claim 1, wherein the adjustable headset is retractable and waterproof.

6. The headset of claim 1, wherein the headband is curved shaped headband for displacement towards the back of the head of the user to rest on the ears.

7. The headset of claim 1, wherein each of the two spherical assemblies comprises Styrofoam liners for providing comfort and solidify sounds within the ear canal for a personal amphitheater experience.

8. The headset of claim 7, wherein the Styrofoam liner trails along the edges of the spherical cups.

9. The headset of claim 7, wherein inner surface of the first earcup and second earcup are lined with Styrofoam.

10. The headset of claim 1, wherein the headband is made of recyclable plastic.

11. The headset of claim 1, wherein the adapter assembly is connected via a hole present in the first earcup and the second earcup where the adapted assembly is attached associated with the headband that are opened face pointing forward and enclosed around the ear.

12. An adjustable and retractable headset to enhance the volume of sound in areas of interest, the adjustable and retractable headset comprising:
a headband having a first end and a second end, the headband being placed to the rear of a user's head facing inward for comfort and modernization;
at least two circular assemblies that fit ears of plurality of users for augmenting sound for the users, the circular assemblies comprise:
a first earcup attached to a first end of the headband via an adapter assembly,
a second earcup connected to the second end of the headband via the adapter assembly,
the adapter assembly being pivotally attached to the first end of the headband permitting inward and outward pivotal movement of the first earcup and the second earcup with respect the headband; and
a mechanism associated with the headband and each of the two circular assemblies for selectively adjusting the extent of outward pivotal movement of each of the two circular assemblies with respect to the headband.

13. The adjustable and retractable headset of claim 12, wherein the adjustable and retractable headset is waterproof.

14. The adjustable and retractable headset of claim 12, wherein the headband is curved shaped headband for displacement towards the back of the head of the user to rest on the ears.

15. The adjustable and retractable headset of claim 12, wherein each of the two spherical assemblies comprises Styrofoam liners for providing comfort and solidify sounds within the ear canal for a personal amphitheater experience.

16. The adjustable and retractable headset of claim 15, wherein the Styrofoam liner trails along the edges of the spherical cups.

17. The adjustable and retractable headset of claim 15, wherein an inner surface of the first and second earcups are lined with Styrofoam.

18. The adjustable and retractable headset of claim 12, wherein the headband is made of recyclable plastic.

19. The adjustable and retractable headset of claim 12, wherein the adapter assembly is connected via a hole present in the first earcup and the second earcup associated with the headband that are opened face pointing forward and enclosed around the ear.

20. The adjustable and retractable headset of claim 12, wherein the headband is a retractable headband.
